(19) United States
(12) Patent Application Publication
(10) Pub. No.: US 2022/0209611 A1
(43) Pub. Date: Jun. 30, 2022

(54) ROTATING ELECTRIC MACHINE AND METHOD OF MANUFACTURING CORE

(71) Applicant: ICHINOMIYA DENKI CO., LTD., Shisou-shi, Hyogo (JP)

(72) Inventors: Yoshikazu KINASHI, Shisou-shi, Hyogo (JP); Hiroki KONISHI, Shisou-shi, Hyogo (JP)

(21) Appl. No.: 17/606,832

(22) PCT Filed: Apr. 24, 2020
(86) PCT No.: PCT/JP2020/017803

§ 371 Date: Oct. 27, 2021

(30) Foreign Application Priority Data
May 10, 2019 (JP) 2019-089914

(51) Int. Cl. H02K 3/42; H02K 1/14; H02K 1/278; H02K 3/32; H02K 21/16; H02K 15/02; H02K 15/12

(52) U.S. Cl. CPC H02K 3/42; H02K 1/146; H02K 1/278; H02K 15/12; H02K 21/16; H02K 15/022; H02K 3/325

(57) ABSTRACT

To reduce a loss of a rotating electric machine by making it difficult for an eddy current to occur in a welding portion of the rotating electric machine. A rotating electric machine includes a rotor including a magnet on an outer circumferential portion, a stator core having plural teeth facing the outer circumferential portion of the rotor via a gap, an electric insulator covering a part of a surface of the stator core, and plural coils wound around the stator core via the electric insulator. The stator core has plural steel plates stacked in an axial direction. At least two plural steel plates [adjacent to each other in the axial direction, of the plural steel plates, are welded at a position on the surface of the stator core, the position being outside a closed magnetic circuit generated in the stator core. The plural steel plates are not welded at a position on the surface of the stator core where each tooth faces the rotor.

### TECHNICAL FIELD

The present invention relates to a rotating electric machine that is an electric motor or a generator, and a method of manufacturing a core.

### BACKGROUND ART

In an inner rotor type electric motor, a core of a stator is usually formed by stacking plural steel plates. A structure in which a dowel crimping portion is formed on each of the stacked steel plates is mainly used. The dowel crimping portion is recessed from one surface of the steel plate and protrudes from the other surface of the steel plate. The plural steel plates are coupled to each other by fitting each dowel crimping portion in a stacking direction.

### CITATION LIST

### Patent Literature

Patent Literature 1: Japanese Patent Laid-Open No. 2018-11410

### SUMMARY OF THE INVENTION

### Technical Problem

When a rotational speed of the electric motor is increased, a torque required for the electric motor is reduced. As a result, a size of the electric motor can be reduced. As the rotational speed of the electric motor increases, a loss of the electric motor due to an eddy current generated in the steel plate increases. In response, for example, when a thin steel plate having a thickness of 0.3 mm or less is used, the eddy current generated in a thickness direction of each steel plate can be reduced. However, it is difficult to form the dowel crimping portion on the thin steel plate.

It is conceivable that the stacked steel plates are coupled by welding using a laser or the like instead of the dowel crimping portion. However, since the plural steel plates are continuous in the thickness direction, an eddy current generated in a welding portion increases.

The present invention is made in view of circumstances described above. An object of the present invention is to provide a means of reducing a loss of a rotating electric machine by making it difficult for an eddy current to occur in a welding portion of the rotating electric machine.

### Solution to Problem

(1) A rotating electric machine according to a first aspect of the present invention includes: a rotor rotatable about an axis line extending in a first direction, the rotor including a magnet at an outer circumferential portion; a core including plural teeth facing the outer circumferential portion of the rotor via a gap; an insulator covering a part of a surface of the core; and plural coils wound around the core via the insulator. The core includes plural steel plates stacked in the first direction. Each of the plural steel plates has a thickness of 0.3 mm or less in the first direction. At least two steel plates adjacent to each other in the first direction, of the plural steel plates, are welded at a position on the surface of the core, the position being outside a closed magnetic circuit generated in the core. The plural steel plates are not welded at an outer surface of each of the teeth, the outer surface facing the rotor.

With the above configuration, a magnetic flux emitted from the magnet is prevented from passing through the welding portion.

(2) The core includes plural steel plate units each including m pieces of the steel plates stacked in the first direction and bonded to each other with an adhesive, m being an integer of two or more. Each of the steel plate units is stacked in the first direction. The steel plates that are located at an end in the first direction in each of the steel plate units and are adjacent to each other in the first direction are welded.

With the above configuration, it is possible to relatively reduce the number of welding portions in the core.

(3) A resin mold surrounding a portion of each of the teeth, the portion being close to the gap is further provided.

With the above configuration, it is possible to prevent a portion of each tooth from being opened, the portion being close to the gap.

(4) A rotating electric machine according to a second aspect of the present invention includes: a rotor rotatable about an axis line extending in a first direction, the rotor including a magnet at an outer circumferential portion; three or more split cores each including: a yoke separated from the outer circumferential portion of the rotor in a second direction intersecting the axis line; and two teeth extending from two ends of the yoke in a third direction intersecting the first direction and the second direction, the two teeth facing the outer circumferential portion of the rotor via a gap; three or more insulators covering each of the yokes; and three or more coils each wound around the yoke via each of the insulators. Each of the split cores includes plural steel plates stacked in the first direction. Each of the plural steel plates has a thickness of 0.3 mm or less in the first direction. At least two steel plates adjacent to each other in the first direction, of the plural steel plates, are welded at a welding portion outside a closed magnetic circuit generated in the split core on a surface of the split core, the welding portion being at an end of the yoke in the third direction. The plural steel plates are not welded at an outer surface of each of the teeth, the outer surface facing the rotor.

With the above configuration, an eddy current can be reduced.

(5) Each of the split cores includes three or more steel plate units each including m pieces of the steel plates stacked in the first direction and bonded to each other with an adhesive, m being an integer of two or more. The three or more steel plate units are stacked in the first direction. The steel plates that are located at an end in the first direction in each of the steel plate units and are adjacent to each other in the first direction are welded at the welding portion. One and another one of two welding portions adjacent to each other in the first direction are at one end and another end of the yoke in the third direction.

With the above configuration, it is possible to relatively reduce the number of welding portions in the core.

(6) Each of the teeth has a surface extending along the second direction from two ends of the yoke in the third direction to the gap.

(7) The rotating electric machine further includes a resin mold surrounding each of the teeth in an extending end side of each of the teeth.

With the above configuration, it is possible to prevent a portion of each of the teeth from being opened, the portion being close to the gap.

(8) A rotating electric machine according to a third aspect of the present invention includes: a rotor rotatable about an axis line extending in a first direction, the rotor including a magnet at an outer circumferential portion; three or more split cores each including: a yoke separated from the outer circumferential portion of the rotor in a second direction intersecting the axis line; and two teeth extending from two ends of the yoke in a third direction intersecting the first direction and the second direction, the two teeth facing the outer circumferential portion of the rotor via a gap; three or more insulators covering each of the yokes; and three or more coils each wound around the yoke via each of the insulators. Each of the split cores includes plural steel plates stacked in the first direction. At least two steel plates adjacent to each other in the first direction, of the plural steel plates, are welded at a welding portion outside a closed magnetic circuit generated in the core on a surface of the core, the welding portion being at an end of the yoke in the third direction. The plural steel plates are not welded at an outer surface of each of the teeth, the outer surface facing the rotor. Each of the teeth has a surface extending along the second direction from the two ends of the yoke in the third direction to the gap.

(9) Each of the split cores includes three or more steel plate units each including m pieces of the steel plates stacked in the first direction and bonded to each other with an adhesive, m being an integer of two or more. The three or more steel plate units are stacked in the first direction. The steel plates that are located at an end in the first direction in each of the steel plate units and are adjacent to each other in the first direction are welded at the welding portion. One and another one of two welding portions adjacent to each other in the first direction are at one end and another end of the yoke in the third direction.

(10) The rotating electric machine further includes a resin mold surrounding each of the teeth in an extending end side of each of the teeth.

(11) A fourth aspect of the present invention provides a method for manufacturing a core, the method including a welding step of stacking plural steel plates in a first direction and welding the plural steel plates, the plural steel plates each having a planar shape of the core and a thickness of 0.3 mm or less. A welded body produced in the welding step includes a yoke and a tooth extending from the yoke in a second direction intersecting the first direction. In the welding step, at least two steel plates adjacent to each other in the first direction, of the plural steel plates, are welded by a welding device at a position outside a closed magnetic circuit generated in the yoke on a surface of the yoke, and are not welded at the tooth. The manufacturing method further includes: covering a surface of the welded body with an insulator; and winding a metal wire around the insulator.

(12) The welding device forms a welding portion having a welding spot diameter of 0.2 mm or more and 0.3 mm or less.

(13) A fifth aspect of the present invention provides a method for manufacturing a core, the method including: a stacking step of bonding plural steel plates with an adhesive and stacking the plural steel plates; a molding step of forming a steel plate unit by punching the plural stacked steel plates into a shape of the core; and a welding step of forming the core by stacking the plural steel plate units in a first direction and welding the plural steel plate units to each other. The core includes: a yoke extending in a third direction intersecting the first direction; and two teeth extending from two ends of the yoke in a second direction intersecting the first direction and the third direction. Each of the teeth has a surface extending along the second direction from the two ends of the yoke in the third direction to the gap. In the welding step, at least two steel plates adjacent to each other in the first direction, of the plural steel plates, are welded at a welding portion outside a closed magnetic circuit generated in the core on a surface of the core, the welding portion being at the two ends of the yoke in the third direction. The plural steel plates are not welded at an outer surface of each of the teeth, the outer surface facing the rotor.

(14) A sixth aspect of the present invention provides a method for manufacturing a core, the method including: a welding step of stacking plural steel plates in a first direction and welding the plural steel plates, the plural steel plates each having a planar shape of the core. A welded body produced in the welding step includes a yoke and a tooth extending from the yoke in a second direction intersecting the first direction. In the welding step, at least two steel plates adjacent to each other in the first direction, of the plural steel plates, are welded at a position outside a closed magnetic circuit generated in the yoke on a surface of the yoke, and are not welded at the tooth. The manufacturing method further includes: covering a surface of the welded body with an insulator; and winding a metal wire around the insulator in a state where a jig is attached to a portion of the tooth that is close to a tooth tip surface and a portion of the tooth that is close to a tooth tip is fixed in the first direction.

### Advantageous Effects of Invention

According to the present invention, it is possible to reduce a loss of a rotating electric machine by making it difficult for an eddy current to occur in a welding portion of the rotating electric machine.

### BRIEF DESCRIPTION OF DRAWINGS

FIG. 1 is a schematic view showing configurations of a rotating electric machine 10 and a controller 37 according to an embodiment of the present invention.

FIG. 2 is a schematic view of a cross section of the rotating electric machine 10 taken along a line II-II in FIG. 1 when viewed from an axial direction 102.

FIG. 3 is a schematic view showing a disposition of magnets 40 in FIG. 1 and a magnetic field distribution in a stator core 42.

FIG. 4 is a schematic view showing an example of a closed magnetic circuit 42C in the stator core 42.

FIG. 5 is a schematic view showing a manufacturing process of the stator core 42.

FIG. 6 is a schematic view showing a modification example of a stator 33.

FIG. 7 is a schematic view of a split core 71 in FIG. 6 when viewed from a centrifugal direction 111.

### DESCRIPTION OF EMBODIMENTS

Hereinafter, a rotating electric machine 10 according to an embodiment of the present invention will be described. The embodiment described below is merely an example of the present invention, and it is needless to say that the embodiment can be appropriately changed without changing the gist of the present invention.

[Schematic Configuration of Rotating Electric Machine 10]

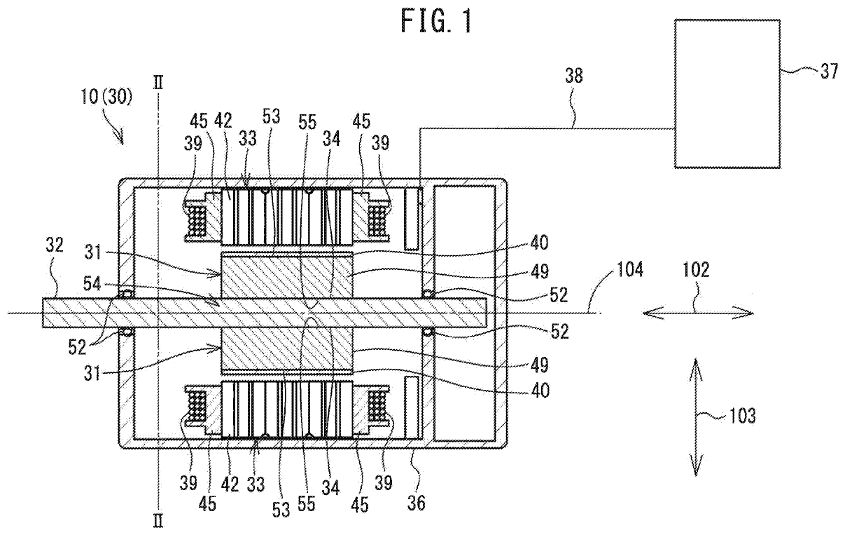

As shown in FIG. 1, the rotating electric machine 10 is an electric motor, and more specifically, is an inner rotor type brushless motor 30. The brushless motor 30 includes a rotor 31, a shaft 32, a stator 33, and the like inside a housing 36. The brushless motor 30 is electrically connected to a controller 37 via a harness 38. The controller 37 applies an AC voltage of any one of a U phase, a V phase, and a W phase to each of twelve coils 39 of the brushless motor 30 via the harness 38.

[Rotor 31]

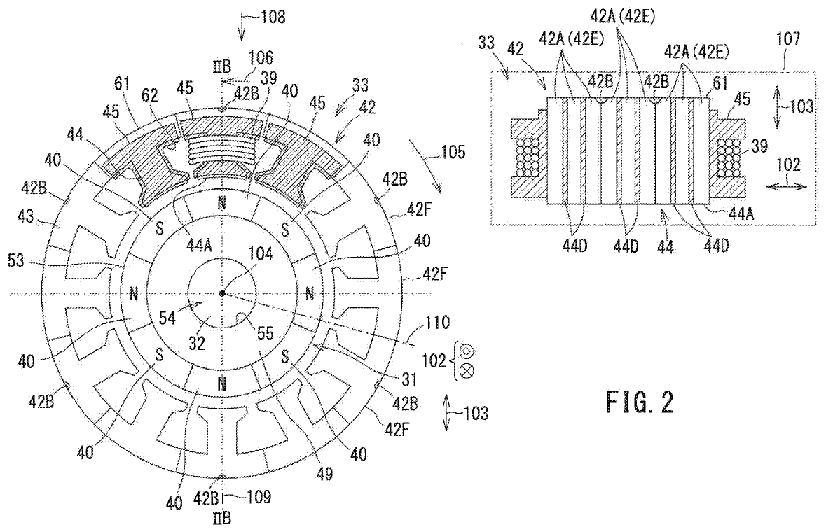

In FIGS. 1 and 2, the rotor 31 is rotatable about an axis line 104. The axis line 104 is indicated by a dash-dotted line in FIG. 1. An axial direction 102 in which the axis line 104 extends is an example of a first direction. The rotor 31 includes a rotor core 49. The rotor core 49 is a stacked body in which plural thin steel plates each having a substantially annular shape are stacked in the axial direction 102. Specifically, the steel plate is an electromagnetic steel plate. The rotor core 49 has a substantially cylindrical shape and includes an outer circumferential surface 53 (an example of an outer circumferential portion) and an inner circumferential surface 55. The outer circumferential surface 53 and the inner circumferential surface 55 are substantially columnar surfaces having different diameters from each other. The outer circumferential surface 53 and the inner circumferential surface 55 share the axis line 104 as a central axis. The inner circumferential surface 55 defines a through hole 54.

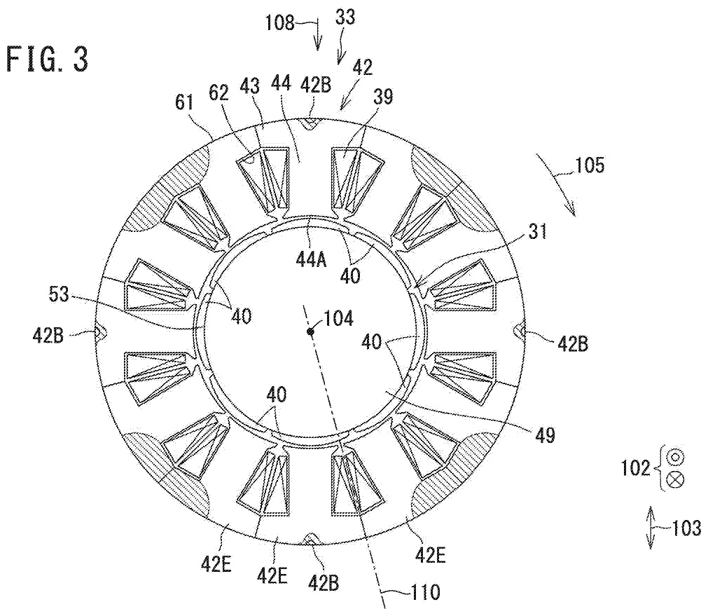

As shown in FIG. 2, the rotor 31 includes eight magnets 40. Each magnet 40 is a permanent magnet. When viewed from the axial direction 102, the eight magnets 40 are disposed on the rotor core 49 at an equal angular interval in a circumferential direction 105 around the axis line 104. More specifically, the eight magnets 40 are disposed such that N poles and S poles alternately appear on the outer circumferential surface 53 in the circumferential direction 105 (see FIG. 2), and are exposed from the outer circumferential surface 53 (see FIG. 3). The eight magnets 40 have the same shape as each other, and have a length spanning both end surfaces in the axial direction 102 in the rotor 31 (see FIG. 1).

[Shaft 32]

As shown in FIG. 1, the shaft 32 is a member having a columnar shape that is longer than the rotor 31 in the axial direction 102. The shaft 32 has substantially the same diameter as a diameter of the through hole 54 formed in the rotor core 49. The shaft 32 is inserted into the through hole 54. Both ends of the shaft 32 protrude from the through hole 54 in the axial direction 102. In this inserted state, the shaft 32 is fixed to the inner circumferential surface 55 of the rotor core 49. The shaft 32 is supported by the housing 36 on both sides in the axial direction 102 via two bearings 52 provided in the housing 36. Accordingly, the shaft 32 is rotatable together with the rotor 31 with respect to the housing 36 in the circumferential direction 105. One end of the shaft 32 in the axial direction 102 protrudes from the housing 36 in the axial direction 102.

[Schematic Configuration of Stator 33]

As shown in FIGS. 1 and 2, the stator 33 includes a stator core 42 (an example of a core), twelve electric insulators 45 (an example of an insulator), and the twelve coils 39. In FIG. 2, only three electric insulators 45 and one coil 39 are shown.

[Stator Core 42]

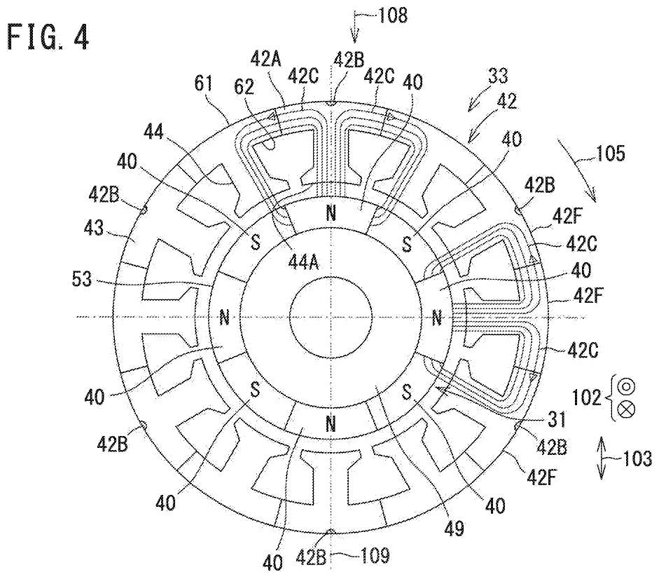

The stator core 42 is disposed to surround the outer circumferential surface 53 of the rotor 31 and has a substantially cylindrical shape. Closed magnetic circuits 42C heading from the N poles to the S poles (see FIG. 4) on the outer circumferential surface 53 are formed inside the stator core 42. In FIG. 4, only two closed magnetic circuits 42C are shown. The stator core 42 includes a stator yoke 43 and twelve teeth 44. In FIGS. 2 and 3, a reference numeral 44 is attached to only one tooth.

The stator yoke 43 has a cylindrical shape and has an outer circumferential surface 61 and an inner circumferential surface 62. The outer circumferential surface 61 and the inner circumferential surface 62 are substantially columnar surfaces having different diameters from each other. The outer circumferential surface 61 and the inner circumferential surface 62 share the axis line 104 as a central axis. The inner circumferential surface 62 has a diameter larger than the diameter of the outer circumferential surface 53 of the rotor 31.

The twelve teeth 44 have the same shape as each other. When viewed from the axial direction 102, the twelve teeth 44 are disposed on the inner circumferential surface 62 at an equal angular interval in the circumferential direction 105. Each tooth 44 extends from the inner circumferential surface 62 toward the axis line 104 in an extending direction 108 parallel to a radial direction 103. The radial direction 103 is a direction orthogonal to the axis line 104. In FIG. 2 and the like, only one example of the radial direction 103 is shown. The extending direction 108 is an example of a second direction. In FIGS. 2 to 4, only one arrow indicating the extending direction 108 is shown. An extending end of each tooth 44 is a tooth tip surface 44A. Each tooth tip surface 44A is separated from the outer circumferential surface 53 of the rotor 31 and each magnet 40. That is, each tooth 44 faces the outer circumferential surface 53 of the rotor 31 via a gap. In FIGS. 2 and 3, a reference numeral 44A is attached to only one tooth tip surface.

In a frame 107 of a double-dashed line in FIG. 2, apart of the stator core 42 is schematically shown when a cross section along a dash-dotted line IIB-IIB is viewed from a direction of an arrow 106. As shown in the frame 107, the stator core 42 is a stacked body in which plural steel plates 42A (specifically, electromagnetic steel plates) are stacked in the axial direction 102. Each steel plate 42A preferably has a thickness of 0.3 mm or less in the axial direction 102. Two adjacent steel plates 42A of the plural steel plates 42A are welded at a welding portion 42B by a laser or the like. The two adjacent steel plates 42A are two steel plates 42A adjacent to each other in the axial direction 102.

As shown in the frame 107, the welding portion 42B is located at a position on the surface of the steel plate 42A, the position serving as the outer circumferential surface 61 of the surface of the stator core 42. As shown in FIG. 4, the welding portion 42B is located at a position of the steel plate 42A, the position being outside the closed magnetic circuit 42C generated in the stator core 42, of the surface of the stator core 42. As shown in the frame 107, the plural steel plates 42A are not welded at a position that serves as a surface of the tooth 44, of the surface of the stator core 42. More specifically, the plural steel plates 42A are not welded at a position that faces the outer circumferential surface 53 of the rotor 31 and serves as the tooth tip surfaces 44A in each tooth 44.

As shown in FIG. 2, the welding portion 42B is also at a position on the surface of the steel plate 42A where a virtual line 109 intersects the outer circumferential surface 61 (an example of an outer surface of the core) of the stator yoke 43. The virtual line 109 is a line that intersects the tooth tip surface 44A of each tooth 44 and is parallel to the radial direction 103 and the extending direction 108. The virtual line 109 is also the dash-dotted line IIB-IIB in FIG. 2. More specifically, the virtual line 109 intersects a center of the tooth tip surface 44A in the circumferential direction 105.

As shown in the frame 107 in FIG. 2, a part of the adjacent steel plates 42A included in the plural steel plates 42A are welded by the laser or the like, and the remaining adjacent steel plates 42A are bonded with an adhesive 42D.

As shown in the frame 107 in FIG. 2, the stator core 42 includes plural steel plate units 42E. Each steel plate unit 42E includes m pieces of the steel plates 42A stacked in the axial direction 102 and bonded with the adhesive 42D. In the present embodiment, when m=3, three steel plates 42A are bonded with the adhesive 42D to constitute one steel plate unit 42E. In the present embodiment, the three steel plate units 42E are stacked in the axial direction 102. The steel plates 42A that are located at an end in the axial direction 102 in each steel plate unit 42E and are adjacent to each other in the axial direction 102 are welded at the welding portion 42B.

As shown in FIG. 2, the stator core 42 includes twelve split cores 42F that are split for each tooth 44. In FIGS. 2 and 3, reference numerals 42E are attached to only three split cores. A split position is a position where a virtual surface 110 intersects the stator yoke 43. The virtual surface 110 is a virtual plane that passes through an intermediate position between two teeth 44 adjacent to each other in the circumferential direction 105 and the axis line 104. In FIGS. 2 and 3, only one virtual surface 110 is shown. One tooth 44 extends from the inner circumferential surface 62 of each split core 42F. Two split cores 42F adjacent to each other in the circumferential direction 105 are bonded with an adhesive (not shown) or the like.

[Electric Insulator 45]

The twelve electric insulators 45 cover a part of the surface of the stator core 42. Each of the twelve electric insulators 45 covers a portion of each of the twelve teeth 44. Each electric insulator 45 covers a portion of the surface of the corresponding tooth 44 excluding the tooth tip surface 44A. Each electric insulator 45 also covers a part of the inner circumferential surface 62 of the stator yoke. In each electric insulator 45, both end portions in the radial direction 103 are longer in the circumferential direction 105 than an intermediate portion between the end portions. Accordingly, the coil 39 wound around the intermediate portion is prevented from coming off the tooth 44. Each electric insulator 45 is implemented with a resin mold fixed to the corresponding tooth 44. The resin mold is a molded product of a resin having an electric insulating property.

[Coil 39]

As shown in FIG. 2, each coil 39 is wound around each tooth 44 via the electric insulator 45. Specifically, each coil 39 is wound around the intermediate portion of the electric insulator 45. An AC voltage of a U phase, a V phase, and a W phase is applied to each coil 39 by the controller 37 (see FIG. 1). A rotating magnetic field is formed in a space surrounded by the twelve teeth 44. Accordingly, the rotor 31 rotates.

[Method for Manufacturing Stator Core 42]

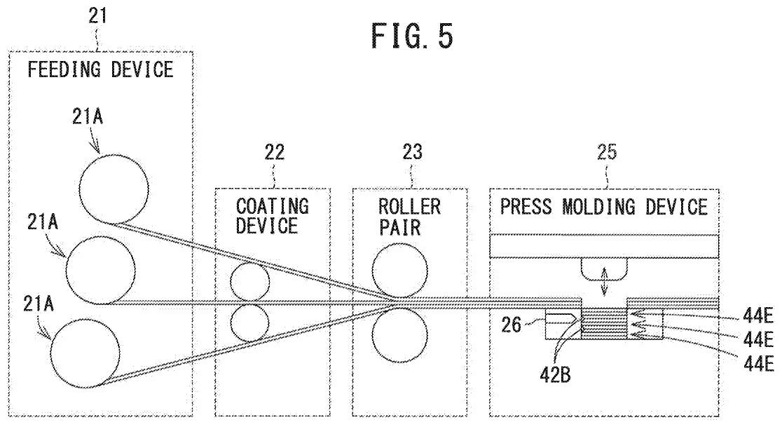

Hereinafter, a method of manufacturing the stator core will be described with reference to FIG. 5. The manufacturing method includes a stacking step, a molding step, a welding step, and the like.

In the stacking step, plural steel plates are bonded with an adhesive and are stacked. Details of the stacking step are as follows.

As shown in FIG. 5, three winding coils 21A are set in a feeding device 21. In the feeding device 21, plural winding coils 21A may be set, not limited to the three winding coils 21A. A steel strip having a thickness of 0.3 mm or less is wound around each winding coil 21A. The feeding device 21 feeds three steel strips to a roller pair 23 in a state where positions of the three steel strips are aligned in a width direction. A coating device 22 is disposed between the feeding device 21 and the roller pair 23. The coating device 22 applies an adhesive such as an epoxy resin adhesive to bonding surfaces of the three steel strips. The roller pair 23 presses the three steel strips fed to the roller pair 23, from a front surface side and a back surface side. Accordingly, the three steel strips are bonded and stacked in a direction orthogonal to surfaces thereof.

In the molding step, plural stacked steel strips (hereinafter, referred to as a stacked body of the steel strips) are punched into a predetermined shape corresponding to the split core 42F having the teeth 44, thereby manufacturing a steel plate unit 44E. Details of the molding step are as follows.

The stacked body of the steel strips is set in a press molding device 25, and is conveyed in the press molding device 25. The press molding device 25 repeatedly punches the stacked body of the steel strips with a mold corresponding to the predetermined shape. Accordingly, the press molding device 25 manufactures plural steel plate units 44E.

In the welding step, the plural steel plate units 44E are stacked and welded to each other. Details of the welding step are as follows.

The plural steel plate units 44E are stacked into a shape of the split core 42F in the press molding device 25. A welding device 26 is provided in the press molding device 25, and welds the welding portions 42B of the split cores 42F to a manufacture welded body (that is, split core 42F).

The molding step and the welding step are repeated to manufacture the twelve split cores 42F.

The twelve electric insulators 45 are manufactured by a molding device (not shown). The twelve electric insulators 45 are attached to twelve welded bodies (that is, the split cores 42F) one by one. A jig is attached to each welded body. Specifically, the jig prevents a tooth tip surfaces 44A side of the plural steel plate units 44E included in each welded body from being opened. Each of the welded bodies to which the jig is attached is set in a coil winding device. The coil winding device 28 winds a metal wire around each electric insulator 45. Accordingly, the twelve split cores 42F around which the coils 39 are respectively wound are manufactured, and the twelve split cores 42F are completed. The twelve split cores 42F are joined together in the circumferential direction 105 with an adhesive or the like. Accordingly, the stator 33 is completed.

[Operational Effects of Rotating Electric Machine 10]

In the rotating electric machine 10 (that is, the brushless motor 30), the plural steel plates 42A are welded at the welding portions 42B. The plural steel plates 42A are not welded at a position on the surface of the stator core 42, where each tooth 44 faces the outer circumferential surface 53 of the rotor 31. The welding portions 42B are located at positions outside or on an outer side of the closed magnetic circuits 42C generated in the stator core 42. In the stator core 42, a magnetic flux density is reduced at the welding portions 42B and portions around the welding portions 42B (see a hatched portion in FIG. 3). Therefore, all or most of the magnetic flux passing through the stator core 42 (that is, the closed magnetic circuit 42C (see FIG. 4)) avoids each welding portion 42B. In other words, the welding portions 42B are located at positions where the magnetic flux density generated in the stator core 42 is relatively small while the rotor 31 rotates around the axis line 104. Accordingly, it is possible to reduce a loss of the rotating electric machine 10 by making it difficult for an eddy current to occur in the welding portion 42B of the rotating electric machine 10 (that is, the brushless motor 30). According to the rotating electric machine 10, by welding at the welding portions 42B, an efficiency of the rotating electric machine 10 is improved since an eddy current loss is not excessively large even at high speed rotation (for example, 5,000 rpm or more).

In the stator core 42, all the steel plates 42A are not necessarily welded. The stator core 42 includes the plural steel plate units 42E. Therefore, it is possible to relatively reduce the welding portions 42B in the stator core 42. Accordingly, the magnetic flux emitted from the magnet 40 is prevented from passing through the welding portions 42B.

In the press molding step, the steel plate units 42E are manufactured by punching the plural steel strips, instead of manufacturing the steel plate 42A one by one by punching one steel strip. Accordingly, the number of times of punching when manufacturing the stator core 42 is restrained.

The electric insulator 45 is a resin mold fixed to each tooth 44. In the manufacturing process of the stator core 42, the electric insulator 45 together with the jig prevents the tooth tip surfaces 44A side of the plural steel plate units 44E from being opened. Since the coil 39 is wound around each electric insulator 45 in this state, the tooth tip surfaces 44A side of the plural steel plate units 44E are prevented from being opened even in a finished product of the stator core 42.

Since the stator core 42 includes three or more split cores 42F, more stator cores 42 can be manufactured from the steel strip as compared with a case where the stator core 42 does not include the split cores 42F.

### Modification Example

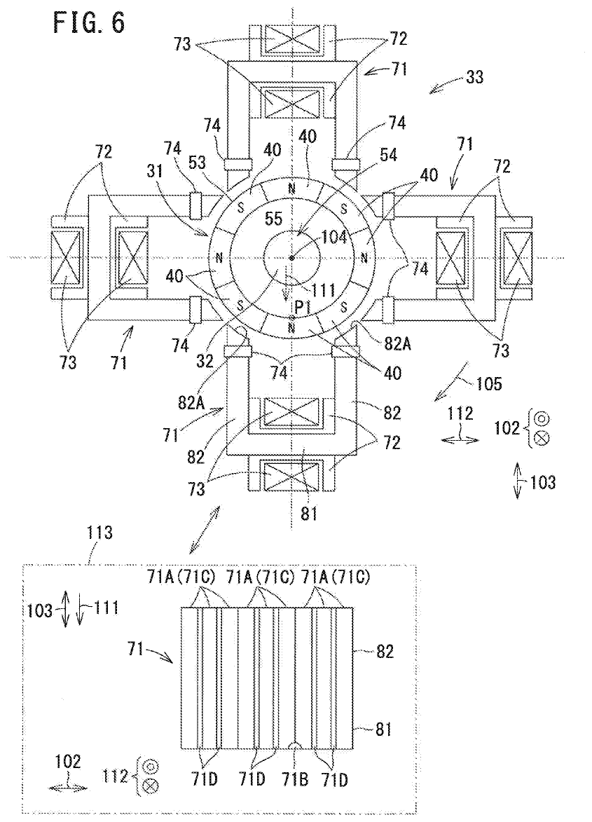

Next, a modification example of the stator 33 will be described with reference to FIG. 6. In the following description of the modification example of the stator 33, differences from the above embodiment will be described.

As shown in FIG. 6, the stator 33 includes four split cores 71 (another example of the core), four electric insulators 72, and four coils 73.

The four split cores 71 have the same shape as each other. When viewed from the axial direction 102, the four split cores 71 are disposed around the outer circumferential surface of the rotor 31 at an equal angular interval in the circumferential direction 105. Except for this point, each split core 71 has a similar configuration to each other. Therefore, hereinafter, one split core 71 will be representatively described. The split core 71 includes a stator yoke 81 and two teeth 82. The stator yoke 81 is an example of a yoke.

The stator yoke 81 is disposed at a position separated from a predetermined position P1 of the outer circumferential surface 53 of the rotor 31 in a centrifugal direction 111. The predetermined position P1 is a position of one point in the circumferential direction 105 on the outer circumferential surface 53. The centrifugal direction 111 is a direction heading from the axis line 104 toward the predetermined position P1, and is another example of the second direction. The stator yoke 81 extends in a tangential direction 112 and the axial direction 102 at the predetermined position P1 of the outer circumferential surface 53. The tangential direction 112 is another example of the third direction. The stator yoke 81 has a length smaller than a diameter of the outer circumferential surface 53 in the tangential direction 112.

One and the other one of the two teeth 82 respectively extend from one end and the other end of the stator yoke 81 in the tangential direction 112 toward the outer circumferential surface 53 of the rotor 31 in parallel to the centrifugal direction 111. An extending end of each tooth 82 is a tooth tip surface 82A. Each tooth tip surface 82A is separated from the outer circumferential surface 53 of the rotor 31 and each magnet 40. That is, each tooth 82 faces the outer circumferential surface 53 via a gap.

The two teeth 82 are surrounded by two resin molds 74 at positions closer to the tooth tip surfaces 82A than to the electric insulator 72. Accordingly, the tooth tip surface 82A side of the tooth 82 is prevented from being opened.

In a frame 113 of a double-dashed line in FIG. 6, the split core 71 is schematically shown when viewed from the tangential direction 112. As shown in the frame 113, the split core 71 is a stacked body in which plural steel plates 71A (specifically, electromagnetic steel plates) are stacked in the axial direction 102. More specifically, a combination of m pieces of steel plates 71A that are continuous in the axial direction 102, of the plural steel plates 71A, constitutes a steel plate unit 71C. In this modification example, when m=3, three steel plates 71A are bonded with an adhesive 71D to constitute one steel plate unit 71C. Each steel plate 71A has a configuration similar to a configuration of each steel plate 42A, except that each steel plate 71A has a shape different from a shape of each steel plate 42A and adjacent steel plates 71A are welded at welding portions 71B in each steel plate unit 71C.

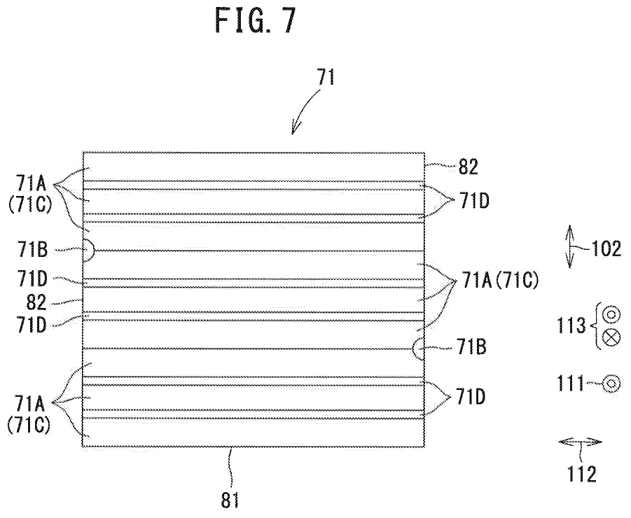

As shown in the frame 113, each welding portion 71B is located at a position of the steel plate 71A, the position being outside a closed magnetic circuit generated in the split core 71, of the surface of the split core 71. As shown in the frame 113, the plural steel plates 71A are not welded at a position that faces the outer circumferential surface 53 of the rotor 31 and serves as the tooth tip surfaces 82A in each tooth 82. Each welding portion 71B is located at an end of the stator yoke 81 in the tangential direction 112. As shown in FIG. 7, the plural welding portions 71B are aligned in a staggered manner in a plan view from the centrifugal direction 111. Specifically, one of two welding portions 71B adjacent to each other in the axial direction 102 is located at one end of the stator yoke 81 in the tangential direction 112, and the other is located at the other end of the stator yoke 81 in the tangential direction 112.

As shown in FIG. 6, the four coils 73 are wound around the four stator yokes 81 one by one. The coil 73 and the stator yoke 81 are electrically separated by the electric insulator 72.

In the above modification example, the plural welding portions 71B are aligned in the staggered manner (see FIG. 7). However, the plural welding portions 71B are not limited thereto and may be located at one end or the other end of the stator yoke 81 in the tangential direction 112. Alternatively, the adjacent steel plates 71A may be welded at both ends (one end and the other end) of the stator yoke 81 in the tangential direction 112.

### OTHER MODIFICATION EXAMPLES

Although the rotating electric machine 10 is an electric motor in the embodiment, the rotating electric machine 10 may be a generator.

In the embodiment, the outer circumferential surface 53 of the rotor core 49 has a substantially columnar shape. The outer circumferential surface 53 is not limited thereto and may have a regular polygonal columnar shape.

In the embodiment, eight magnetic poles are disposed by the eight magnets 40 in the rotor core 49. The magnetic poles are not limited thereto, and two magnetic poles may be disposed in the rotor core 49.

In the embodiment, the rotor 31 is of a surface permanent magnet type (SPM type). That is, each magnet 40 is attached to the outer circumferential surface 53 and is exposed from the outer circumferential surface 53. However, the rotor 31 is not limited thereto and may be of an interior permanent magnet type (IPM type). That is, each magnet 40 may be embedded in the rotor core 49 along the outer circumferential surface while being slightly separated from the outer circumferential surface 53. The phrase “including a magnet at an outer circumferential portion” is a concept including a mode (SPM type) in which each magnet 40 is disposed on the outer circumferential surface 53 in a state of being exposed from the rotor core 49, and a mode (IPM type) in which each magnet 40 is disposed along the outer circumferential surface 53 in a state of not being exposed from the rotor core 49.

In the embodiment, the stator 33 includes twelve sets of the electric insulators 45 and the coils 39, and the stator core 42 includes the twelve teeth 44. However, the stator 33 is not limited thereto and may include three or more sets of electric insulators 45, coils 39, and teeth 44.

In the embodiment, a part of the adjacent steel plates 42A are welded, and the remaining adjacent steel plates 42A are bonded with the adhesive 42D. The adjacent steel plates 42A are not limited thereto, and all of the adjacent steel plates 42A may be welded.

In the embodiment, the stator core 42 includes the twelve split cores 42F. The number of the split cores 42F is not limited to twelve and may be three or more.

### REFERENCE SIGNS LIST

10 rotating electric machine
30 brushless motor
31 rotor
40 magnet
42 stator core (core)
42A steel plate
42C closed magnetic circuit
42E steel plate unit
42F split core
44 tooth
45 electric insulator (insulator)
39 coil

1. A rotating electric machine comprising:
a rotor rotatable about an axis line extending in a first direction, the rotor including a magnet at an outer circumferential portion;
a core including plural teeth facing the outer circumferential portion of the rotor via a gap;
an insulator covering a part of a surface of the core; and
plural coils wound around the core via the insulator, wherein
the core includes plural steel plates stacked in the first direction,
each of the plural steel plates has a thickness of 0.3 mm or less in the first direction,
at least two steel plates adjacent to each other in the first direction, of the plural steel plates, are welded at a position on the surface of the core, the position being outside a closed magnetic circuit generated in the core, and
the plural steel plates are not welded at an outer surface of each of the teeth, the outer surface facing the rotor.

2. The rotating electric machine according to claim 1, wherein
the core includes plural steel plate units each including m pieces of the steel plates stacked in the first direction and bonded to each other with an adhesive, m being an integer of two or more,
each of the steel plate units is stacked in the first direction, and
the steel plates that are located at an end in the first direction in each of the steel plate units and are adjacent to each other in the first direction are welded.

3. The rotating electric machine according to claim 1, further comprising:
a resin mold surrounding a portion of each of the teeth, the portion being close to the gap.

4. A rotating electric machine comprising:
a rotor rotatable about an axis line extending in a first direction, the rotor including a magnet at an outer circumferential portion;
three or more split cores each including:
a yoke separated from the outer circumferential portion of the rotor in a second direction intersecting the axis line; and
two teeth extending from two ends of the yoke in a third direction intersecting the first direction and the second direction, the two teeth facing the outer circumferential portion of the rotor via a gap;
three or more insulators covering each of the yokes; and
three or more coils each wound around the yoke via each of the insulators, wherein
each of the split cores includes plural steel plates stacked in the first direction,
each of the plural steel plates has a thickness of 0.3 mm or less in the first direction,
at least two steel plates adjacent to each other in the first direction, of the plural steel plates, are welded at a welding portion outside a closed magnetic circuit generated in the split core on a surface of the split core, the welding portion being at an end of the yoke in the third direction, and
the plural steel plates are not welded at an outer surface of each of the teeth, the outer surface facing the rotor.

5. The rotating electric machine according to claim 4, wherein
each of the split cores includes three or more steel plate units each including m pieces of the steel plates stacked in the first direction and bonded to each other with an adhesive, m being an integer of two or more,
the three or more steel plate units are stacked in the first direction,
the steel plates that are located at an end in the first direction in each of the steel plate units and are adjacent to each other in the first direction are welded at the welding portion, and
one and another one of two welding portions adjacent to each other in the first direction are at one end and another end of the yoke in the third direction.

6. The rotating electric machine according to claim 4, wherein
each of the teeth has a surface extending along the second direction from two ends of the yoke in the third direction to the gap.

7. The rotating electric machine according to claim 4, further comprising:
a resin mold surrounding each of the teeth in an extending end side of each of the teeth.

8. A rotating electric machine comprising:
a rotor rotatable about an axis line extending in a first direction, the rotor including a magnet at an outer circumferential portion;
three or more split cores each including:
a yoke separated from the outer circumferential portion of the rotor in a second direction intersecting the axis line; and
two teeth extending from two ends of the yoke in a third direction intersecting the first direction and the second direction, the two teeth facing the outer circumferential portion of the rotor via a gap;
three or more insulators covering each of the yokes; and
three or more coils each wound around the yoke via each of the insulators, wherein
each one split core of said three or more split cores includes plural steel plates stacked in the first direction,
at least two steel plates adjacent to each other in the first direction, of the plural steel plates, are welded at a welding portion outside a closed magnetic circuit generated in said one split core on a surface of said one split core, the welding portion being at an end of the yoke in the third direction,
the plural steel plates are not welded at an outer surface of each of the teeth, the outer surface facing the rotor, and
each of the teeth has a surface extending along the second direction from the two ends of the yoke in the third direction to the gap.

9. The rotating electric machine according to claim 8, wherein
each of the split cores includes three or more steel plate units each including m pieces of the steel plates stacked in the first direction and bonded to each other with an adhesive, m being an integer of two or more,
the three or more steel plate units are stacked in the first direction,
the steel plates that are located at an end in the first direction in each of the steel plate units and are adjacent to each other in the first direction are welded at the welding portion, and
one and another one of two welding portions adjacent to each other in the first direction are at one end and another end of the yoke in the third direction.

10. The rotating electric machine according to claim 8, further comprising:
a resin mold surrounding each of the teeth in an extending end side of each of the teeth.

11. A method of manufacturing a core, the method comprising:
a welding step of stacking plural steel plates in a first direction and welding the plural steel plates, the plural steel plates each having a planar shape of the core and a thickness of 0.3 mm or less, wherein
a welded body produced in the welding step includes a yoke and a tooth extending from the yoke in a second direction intersecting the first direction, and
in the welding step, at least two steel plates adjacent to each other in the first direction, of the plural steel plates, are welded by a welding device at a position outside a closed magnetic circuit generated in the yoke on a surface of the yoke, and are not welded at the tooth,
the manufacturing method further comprises:
covering a surface of the welded body with an insulator; and
winding a metal wire around the insulator.

12. A method of manufacturing a core, the method comprising:
a stacking step of bonding plural steel plates with an adhesive and stacking the plural steel plates;
a molding step of forming a steel plate unit by punching the plural stacked steel plates into a shape of the core; and
a welding step of forming the core by stacking the plural steel plate units in a first direction and welding the plural steel plate units to each other, wherein
the core includes:
a yoke extending in a third direction intersecting the first direction; and
two teeth extending from two ends of the yoke in a second direction intersecting the first direction and the third direction,
each of the teeth has a surface extending along the second direction from the two ends of the yoke in the third direction,
in the welding step, at least two steel plates adjacent to each other in the first direction, of the plural steel plates, are welded at a welding portion outside a closed magnetic circuit generated in the core on a surface of the core, the welding portion being at the two ends of the yoke in the third direction, and
the plural steel plates are not welded at an outer surface of each of the teeth, the outer surface facing a rotor.

13. A method of manufacturing a core, the method comprising:
a welding step of stacking plural steel plates in a first direction and welding the plural steel plates, the plural steel plates each having a planar shape of the core, wherein
a welded body produced in the welding step includes a yoke and a tooth extending from the yoke in a second direction intersecting the first direction, and
in the welding step, at least two steel plates adjacent to each other in the first direction, of the plural steel plates, are welded at a position outside a closed magnetic circuit generated in the yoke on a surface of the yoke, and are not welded at the tooth,
the manufacturing method further comprises:
covering a surface of the welded body with an insulator; and
winding a metal wire around the insulator in a state where a jig is attached to a portion of the tooth that is close to a tooth tip surface and a portion of the tooth that is close to the tooth tip surface is fixed in the first direction.
